(19) United States
(12) Patent Application Publication
(10) Pub. No.: US 2015/0204530 A1
(43) Pub. Date: Jul. 23, 2015

(54) CANDLELIGHT SIMULATION ELECTRONIC CANDLE

(71) Applicant: Jerry Lee, Dongguan City (CN)

(72) Inventor: Jerry Lee, Dongguan City (CN)

(21) Appl. No.: 14/160,670

(22) Filed: Jan. 22, 2014

(51) Int. Cl. F21V 23/04; F21S 10/02; F21V 23/00; F21S 10/04

(52) U.S. Cl. CPC F21V 23/0457; F21S 10/046; F21S 10/02; F21V 23/00

(57) ABSTRACT

The present invention relates to a candlelight simulation electronic candle, which comprises a candle body shell and a candle body base, wherein the candle body shell is connected with the candle body base to form an accommodating space; a wick, a casing through hole and a wall are formed on the upper end of the candle body shell; the wick is disposed between the casing through hole and the wall; the accommodating space is provided with a mounting bracket and a lens holder which are hinged to each other, and is also provided with a swinging mechanism which is configured to drive the lens holder to swing around the mounting bracket; and the mounting bracket and the lens holder are respectively provided with a light-emitting element and a lens. to form a flame.

### FIELD OF THE INVENTION

The present invention relates to the technical field of electronic light-emitting devices, in particular to a candlelight simulation electronic candle.

### BACKGROUND OF THE INVENTION

In the everyday life, people originally take candle as a lighting fixture. However, along with the widespread use of electronic light sources, the lighting function is gradually degraded, and the requirement of people on the candle is converted from practicability to ornamental property and sentiment. Therefore, various electronic light-emitting devices such as electronic flash candles, music candles and simulative kerosene lamps are produced.

The prior art discloses an electronic candle, which comprises a light-emitting element, a flame sheet and a swinging mechanism capable of driving the flame sheet to swing, wherein the flame sheet simulates the shape of a real flame after a candle is ignited. After the electrification, the flame sheet is driven to swing by the swinging mechanism; light emitted by the light-emitting element is projected onto the flame sheet; and hence it seems that a real flame is flickering. However, in the power-off state, both the swinging mechanism and the light-emitting element stops operating, and hence the flame sheet looks untrue and the state is greatly different from the real candle extinguishing state, and consequently people can understand fully at one glance that the device is a fake candle device. Therefore, the deceptive objective cannot be achieved and the visual experience is not real enough.

### SUMMARY OF THE INVENTION

The objective of the present invention is to overcome the defects of the prior art and provide a candlelight simulation electronic candle, which can really simulate the use effect of a candle no matter in the power-on state or in the power-off state, is deceptive, and can achieve more real visual experience.

In order to achieve the objective, the candlelight simulation electronic candle mainly adopts the technical proposal that:

The present invention relates to a candlelight simulation electronic candle, which comprises a candle body shell and a candle body base, wherein the candle body shell is connected with the candle body base to form an accommodating space; a wick, a casing through hole and a wall are formed on the upper end of the candle body shell; the wick is disposed between the casing through hole and the wall; the accommodating space is provided with a mounting bracket and a lens holder which are hinged to each other, and is also provided with a swinging mechanism which is configured to drive the lens holder to swing around the mounting bracket; the mounting bracket and the lens holder are respectively provided with a light-emitting element and a lens; a gap is formed between the light-emitting element and the lens; in the power-on state, light of the light-emitting element runs through the lens and the casing through hole in turn, and light emitted from the casing through hole is projected onto the wall and runs through the wick to form a flame; and when the swinging mechanism drives the lens to swing freely along with the lens holder, the flame which is imaged via the lens and projected onto the wall swings freely.

Preferably, a recess is formed on the upper end of the candle body shell; both the wick and the casing through hole are disposed at the bottom of the recess; and the recess and the wall are integrally formed.

Moreover, a longitudinal cross-section of the recess is cambered in shape.

Furthermore, a longitudinal cross-section of the wall is cambered in shape.

Preferably, the swinging mechanism includes a control circuit mounted in the accommodating space; the lens holder and the mounting bracket are respectively provided with a magnet and a solenoid; the control circuit is electrically connected with the solenoid; and in the power-on state, the solenoid products magnetism and the solenoid and the magnet attract or repel each other.

Preferably, the swinging mechanism includes a fan mounted in the accommodating space; the lens holder is provided with a windward baffle; and in the power-on state, the baffle is driven to swing by the wind power generated by the fan.

Preferably, the swinging mechanism includes a motor mounted in the accommodating space; the lens holder is provided with a swinging arm; a motor bushing is provided with a cam which abuts against the swinging arm; and in the power-on state, the motor drives the cam to rotate and the cam drives the swinging arm to swing.

Preferably, the mounting bracket is provided with a mounting hole capable of holding the light-emitting element, and includes a left mounting bracket and a right mounting bracket which are butted with each other; and the mounting hole is divided into two portions which are symmetrically formed on the left mounting bracket and the right mounting bracket respectively.

Preferably, the mounting bracket is provided with a swinging support; the lens holder is provided with an arch support; the swinging support runs through the inside of the arch support; and the arch support is hinged to the swinging support.

Preferably, the candle body shell is provided with a light sensor capable of sensing the illumination intensity.

Preferably, the light-emitting element is a light-emitting diode (LED) color-changing lamp.

Preferably, a color plate is disposed between the light-emitting element and the lens and rotatably mounted on the mounting bracket through a support; and in the power-on state, the light of the light-emitting element runs through the color plate, the lens and the casing through hole in turn, and the light emitted from the casing through hole is projected onto the wall.

Moreover, the candlelight simulation electronic candle further comprises a photoswitch which is mounted on the mounting bracket and connected with the light-emitting element.

Furthermore, the photoswitch is connected with a time-delay device which is connected with the light-emitting element.

The working principle of the candlelight simulation electronic candle is as follows:

In the power-on state, the light of the light-emitting element runs through the lens and is emitted parallelly; the parallelly emitted light runs through the casing through hole and is projected onto the wall; and an elliptical shadow is formed on the wall by the parallelly emitted light and is in the shape of a flame. Moreover, the swinging mechanism also drives the lens holder to swing around the mounting bracket and the lens swings along with the lens holder, and hence the elliptical shadow on the wall will also flicker, and consequently the visual effect of a real flame can be simulated.

The candlelight simulation electronic candle provided by the present invention has the advantages that:

(1) In the power-on state, the swinging mechanism drives the lens to swing along with the lens holder; the elliptical shadow which looks like the flame is formed on the wall by the light emitted from the lens; and the elliptical shadow flickers, and hence the visual effect of the real flame can be simulated and the deceptive objective can be achieved.

(2) As the wick of the candlelight simulation electronic candle provided by the present invention also simulates the shape of a real candle wick, the wick cannot be easily perceived to be false in the power-off state, and hence more real visual effect of the candlelight simulation electronic candle provided by the present invention can be achieved.

### BRIEF DESCRIPTION OF THE DRAWINGS

FIG. 1 is a function diagram illustrating the state when a swinging mechanism of a candlelight simulation electronic candle provided by the present invention swings up;

FIG. 2 is a function diagram when the swinging mechanism of the candlelight simulation electronic candle provided by the present invention is in the horizontal state;

FIG. 3 is a function diagram illustrating the state when the swinging mechanism of the candlelight simulation electronic candle provided by the present invention swings down;

FIG. 4 is a schematic structural view of an embodiment 1 of the candlelight simulation electronic candle provided by the present invention;

FIG. 5 is a schematic structural view of the embodiment 1 of the candlelight simulation electronic candle provided by the present invention in another direction;

FIG. 6 is an exploded view of the embodiment 1 of the candlelight simulation electronic candle provided by the present invention;

FIG. 7 is a sectional view of a candle body shell in the embodiment 1 of the candlelight simulation electronic candle provided by the present invention;

FIG. 8 is a schematic structural view of the embodiment 1 of the candlelight simulation electronic candle provided by the present invention, obtained after a candle body shell is concealed;

FIG. 9 is a schematic structural view of a base in the embodiment 1 of the candlelight simulation electronic candle provided by the present invention;

FIG. 10 is a schematic structural view of a candle body shell of an embodiment 2 of the candlelight simulation electronic candle provided by the present invention;

FIG. 11 is a schematic structural view of an embodiment 3 of the candlelight simulation electronic candle provided by the present invention, obtained after the candle body shell is concealed;

FIG. 12 is a schematic structural view of an embodiment 4 of the candlelight simulation electronic candle provided by the present invention, obtained after the candle body shell is concealed; and

FIG. 13 is a schematic structural view of an embodiment 5 of the candlelight simulation electronic candle provided by the present invention, obtained after the candle body shell is concealed; and

FIG. 14 is a schematic structural view of an embodiment 6 of the candlelight simulation electronic candle provided by the present invention, obtained after the candle body shell is concealed

### REFERENCE NUMERALS OF THE DRAWINGS

1—candle body shell, 101—casing through hole, 102—wall, 103—recess, 104—essential oil tank, 105—USB interface, 2—candle body base, 21—battery chute, 3—wick, 4—mounting bracket, 41—left mounting bracket, 42—right mounting bracket, 43—mounting hole, 44—support arm, 5—lens holder, 51—spacing groove, 6—light sensor, 7—lens, 8—magnet, 9—solenoid, 10—swinging support, 11—arc support, 12—light-emitting element, 13—battery, 14—main circuit board, 15—fan, 16—baffle, 17—motor, 18—swinging arm, 19—cam, 20—gear switch, 121—color plate, 122—support, 22—photoswitch.

### DETAILED DESCRIPTION OF THE PREFERRED EMBODIMENTS

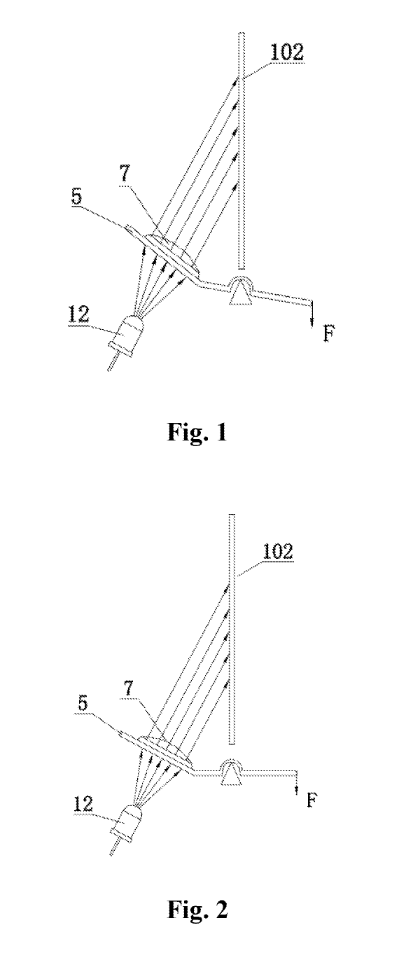

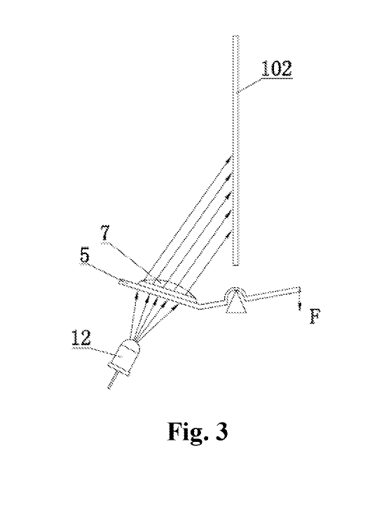

FIGS. 1 to 3 are function diagrams of a candlelight simulation electronic candle provided by the present invention, in which FIG. 1 is a function diagram illustrating the state when a swinging mechanism swings up; FIG. 2 is a function diagram when the swinging mechanism is in the horizontal state; and FIG. 3 is a function diagram illustrating the state when the swinging mechanism swings down. As illustrated in FIGS. 1 to 3, light emitted from a light-emitting element is refracted by a lens 7 and emitted parallelly, in which the lens 7 is a convex lens; an elliptical shadow is formed on a wall 102 by the parallelly emitted light and looks like a burning flame; and the lens 7 is mounted on a lens holder 5 which is a lever mechanism. When a variable force is applied to the tail end of the lens holder 5, the lens 7 will swing along with the front end of the lens holder 5, and hence the elliptical shadow will flicker on the wall, and consequently the visual effect of a real flame can be simulated.

### Embodiment 1

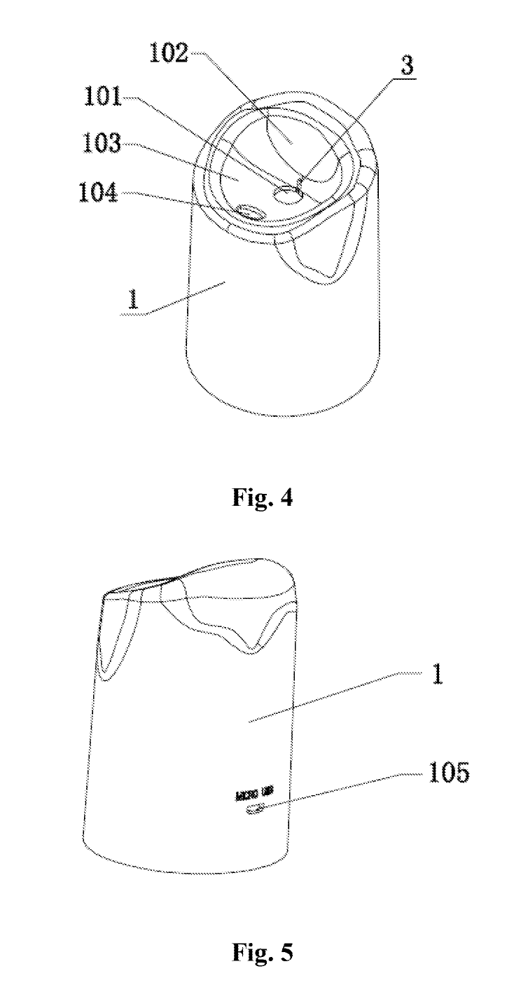

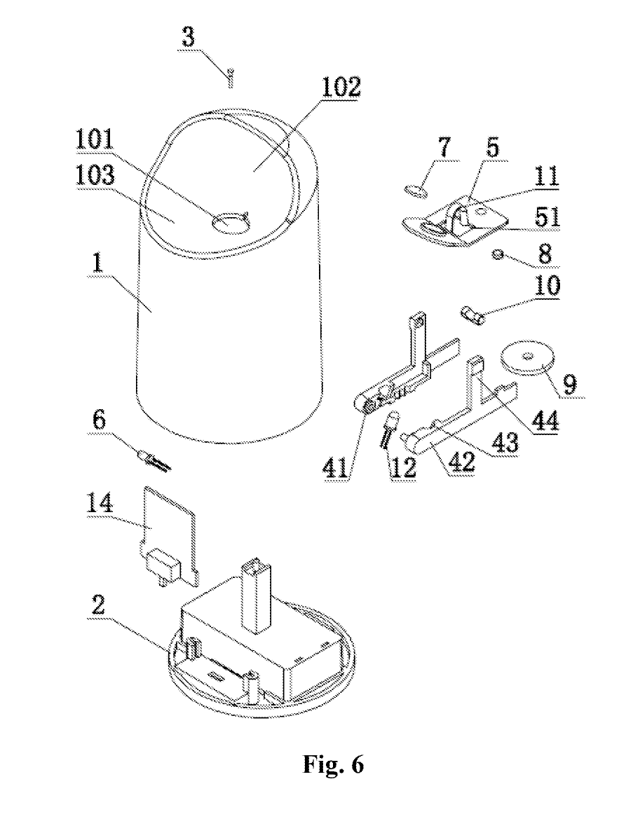

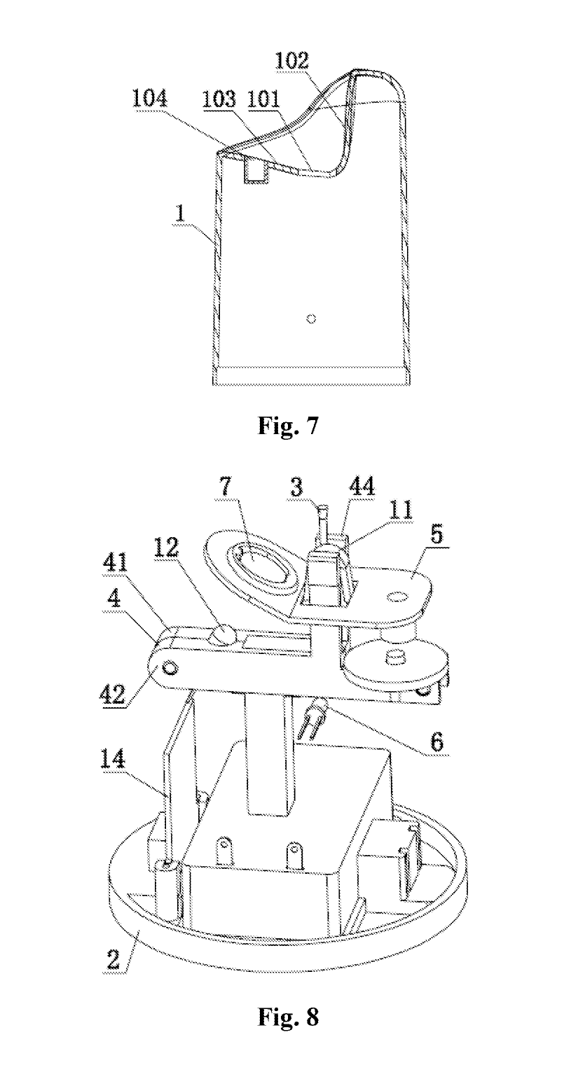

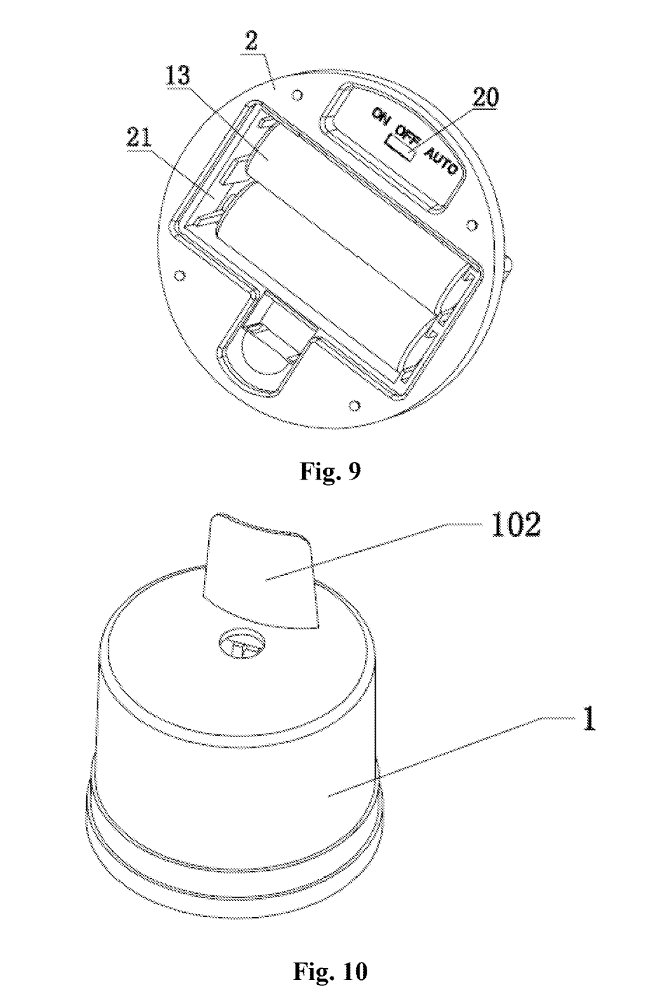

As illustrated in FIGS. 2 to 6, the present invention relates to a candlelight simulation electronic candle, which comprises a candle body shell 1 and a candle body base 2, wherein the candle body shell 1 is connected with the candle body base 2 to form an accommodating space; a wick 3, a casing through hole 101 and a wall 102 are formed on the upper end of the candle body shell 1; the wick 3 simulates the shape of a real candle wick and is disposed between the casing through hole 101 and the wall 102; the accommodating space is provided with a mounting bracket 4 and a lens holder 5 which are movably connected with each other, and is also provided with a swinging mechanism which is configured to drive the lens holder 5 to swing around the mounting bracket 4; the mounting bracket 4 and the lens holder 5 are respectively provided with a light-emitting element 12 and a lens 7; a gap is formed between the light-emitting element 12 and the lens 7; in the power-on state, light of the light-emitting element 12 runs through the lens 7 and the casing through hole 101 in turn, and light emitted from the casing through hole 101 is projected onto the wall 102 to form a flame; and when the swinging mechanism drives the lens 7 to swing freely along with the lens holder 5, the flame which is imaged via the lens 7 and projected onto the wall 102 swings freely. More specifically, an elliptical shadow which looks like a flame is formed on the wall 102 by the light emitted from the casing through hole 101. As the wick 3 is disposed between the casing through hole 101 and the wall 102, the elliptical shadow looks like the burning effect of the wick 3. In the power-on state, the swinging mechanism drives the lens 7 to swing freely along with the lens holder 5 and the elliptical shadow also flickers on the wall 102, and hence the visual effect of a real flame can be simulated and the deceptive objective can be achieved. Moreover, as the wick 3 of the candlelight simulation electronic candle provided by the present invention also simulates the shape of a wick 3 of a real candle, the wick 3 cannot be easily perceived to be false even in the power-off state. Therefore, the candlelight simulation electronic candle provided by the present invention can really simulate the use effect of the candle no matter in the power-on state or in the power-off state, and hence the visual experience can be more real and the deceptive effect can be achieved.

A recess 103 is formed on the upper end of the candle body shell 1; both the wick 3 and the casing through hole 101 are disposed at the bottom of the recess 103; and the recess 103 and the wall 102 are integrally formed. More specifically, the upper end surface of the recess 103 is made into an irregular end surface; and as the front of the irregular end surface is low and the rear of the irregular end surface is high, a notch is formed. Therefore, the irregular change of wax melting during the candle burning can be simulated, and hence the candlelight simulation electronic candle provided by the present invention looks like more real.

A longitudinal cross-section of the recess 103 is cambered in shape. Due to the setting, the effect of the melting of wax near the wick 3 during the candle burning can be simulated, and hence the real use effect of the candlelight simulation electronic candle provided by the present invention can be improved.

A longitudinal cross-section of the wall 102 is cambered in shape. Due to the setting, the effect of the melting of wax near the wick 3 during the candle burning can be simulated, and hence the real use effect of the candlelight simulation electronic candle provided by the present invention can be improved.

The swinging mechanism includes a control circuit which is mounted in the accommodating space; the lens holder 5 and the mounting bracket 4 are respectively provided with a magnet 8 and a solenoid 9; the control circuit is electrically connected with the solenoid 9; and in the power-on state, the solenoid 9 generates magnetism and the solenoid 9 and the magnet 8 attract or repel each other. More specifically, the control circuit supplies the solenoid 9 with random number pulse energy, and hence the magnetism generated by the solenoid 9 is suddenly positive and suddenly negative and the magnetic force of the solenoid 9 is suddenly large and suddenly small. Therefore, in the power-on state, the solenoid 9 generates the magnetism and the solenoid 9 and the magnet 8 attract or repel each other, and hence the lens holder 5 is driven to swing around the mounting bracket 4, and consequently the objective of the flickering of the shadow on the wall 102 can be achieved.

The candle body base 2 is provided with a main circuit board 14; and the control circuit is mounted on the main circuit board 14 which is inserted into the candle body base 2. When the main circuit board 14 is damaged and required for maintenance, the main circuit board 14 can be pulled out in time, and hence the maintenance can be convenient.

The control circuit is electrically connected with the light-emitting element 12. More specifically, the control circuit supplies the light-emitting element 12 with random number pulse energy, and controls the illumination intensity of the light-emitting element 12 so that the light emitted by the light-emitting element 12 is flickering, and hence the candlelight simulation electronic candle provided by the present invention looks more real.

The mounting bracket 4 is provided with a mounting hole 43 capable of holding the light-emitting element 12, and includes a left mounting bracket 41 and a right mounting bracket 42 which are butted with each other; and the mounting hole 43 is divided into two portions which are symmetrically formed on the left mounting bracket 41 and the right mounting bracket 42 respectively. More specifically, the mounting bracket 4 is divided into a plurality of components for design. As the structure of a single component is relatively simple, the processing and the assembly are convenient, and hence the processing cost can be reduced. Moreover, when the single component is damaged, the single component can be replaced and maintained in time, and hence the maintenance cost can be low.

The mounting bracket 4 is provided with a swinging support 10; the lens holder 5 is provided with an arch support 11; the swinging support 10 runs through the inside of the arch support 11; and the arch support 11 is hinged to the swinging support 10. More specifically, the swinging support 10 is fixed on the mounting bracket 4 and the arch support 11 swings to and fro around the swinging support 10 which is taken as a pivot. Therefore, the structure is simple and the swinging is flexible.

The lens holder 5 is provided with a spacing groove 51; and the mounting bracket 4 is provided with a support arm 44 which abuts against the side wall of the spacing groove 51. When the swinging mechanism drives the lens holder 5 to swing, the lens holder 5 swings to a predetermined angle and the support arm 44 abuts against the side wall of the spacing groove 51. The support arm 44 is engaged with the spacing groove 51. The swinging angle of the lens holder 5 can be adjusted, so that overlarge swinging angle of the lens holder 5 can be prevented, and hence more real use effect of the candlelight simulation electronic candle can be achieved.

The candle body shell 1 is provided with a light sensor 6 capable of sensing the illumination intensity. More specifically, the candle body base 2 is provided with a gear switch 20 which has three gears, namely “on”, “off” and “auto”. When the gear switch 20 is in the “auto” gear, the light sensor 6 can automatically sense the illumination intensity of the periphery and can be automatically ignited at night, and hence the practicability of the candlelight simulation electronic candle provided by the present invention can be improved.

Moreover, the candle body shell 1 is provided with an essential oil tank 104. After essential oil is filled into the essential oil tank 104, when the candlelight simulation electronic candle provided by the present invention is used, not only the visual effect of a real flame can be simulated but also a comfortable fragrance environment can be provided for users and hence effectively alleviates the pressure of the users. Of course, a heater may be also disposed under the essential oil tank 104, and hence the spread effect of the essential oil can be further strengthened, and consequently the user comfort can be improved.

The candle body base 2 is also provided with a battery chute 21 capable of holding a battery 13. Due to the setting, the candlelight simulation electronic candle provided by the present invention can be supplied with power by the battery 13 and hence can be convenient to carry.

Of course, power can be supplied for the candlelight simulation electronic candle provided by the present invention from the outside by the arrangement of a USB interface 105 or an external power line. And meanwhile, the objectives of convenient carrying and convenient charging can be achieved, and hence the practicability of the candlelight simulation electronic candle provided by the present invention can be further improved.

The light-emitting element 12 is an LED color-changing lamp. When the light-emitting element 12 is electrified, the LED color-changing lamp can form flickering flames with different colors and hence produce colorful light, and hence the candlelight simulation electronic candle provided by the present invention can be more vivid.

### Embodiment 2

The technical proposal of the embodiment is basically the same with that of the embodiment 1. The difference is as follows:

As illustrated in FIG. 10, in the embodiment, the wall 102 is disposed on the candle body shell 1. The difference of the technical proposal of the embodiment with that of the embodiment 1 is that: the shape and the position of the wall 102 are different.

### Embodiment 3

The technical proposal of the embodiment is basically the same with that of the embodiment 1. The differences are as follows:

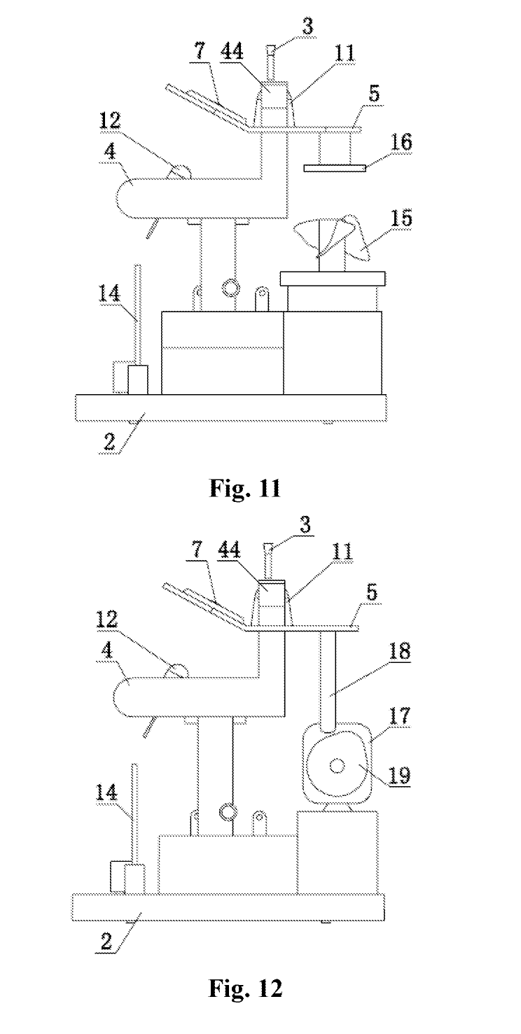

As illustrated in FIG. 11, the swinging mechanism includes a fan 15 which is mounted in the accommodating space; the lens holder 5 is provided with a windward baffle 16; and in the power-on state, the baffle 16 is driven to swing by the wind force generated by the fan 15. More specifically, the lens holder 5, the lens 7 and the baffle 16 are mutually fixed; and when the baffle 16 is driven to swing by the wind force generated by the fan 15, the lens holder 5 and the lens 7 will swing along with the baffle 16, and hence the objective of the flickering of the shadow on the wall 102 can be achieved.

The main technical proposal of the embodiment is basically the same with that of the embodiment 1. Unexplained characteristics in the embodiment adopt the explanation in the embodiment and will not be further described herein.

### Embodiment 4

The technical proposal of the embodiment is basically the same with that of the embodiment 1. The differences are as follows:

As illustrated in FIG. 12, the swinging mechanism includes a motor 17 which is mounted in the accommodating space; the lens holder 5 is provided with a swinging arm 18; a motor bushing is provided with a cam 19 which abuts against the swinging arm 18; and in the power-on state, the motor 17 drives the cam 19 to rotate and the cam 19 drives the swinging arm 18 to swing. More specifically, the swinging arm 18 is disposed on a rotational travel channel of the cam 19; when the motor 17 drives the cam 19 to rotate, the cam 19 will discontinuously collide with the tail end of the swinging arm 18, and hence the swinging arm 18 will be driven to swing disorderly and the lens holder 5 and the lens 7 will swing along with the swinging arm 18, and consequently the objective of the flickering of the shadow on the wall 102 can be achieved.

The main technical proposal of the embodiment is basically the same with that of the embodiment 1. Unexplained characteristics in the embodiment adopt the explanation in the embodiment and will not be further described herein.

### Embodiment 5

The technical proposal of the embodiment is basically the same with that of the embodiment 1. The differences are as follows:

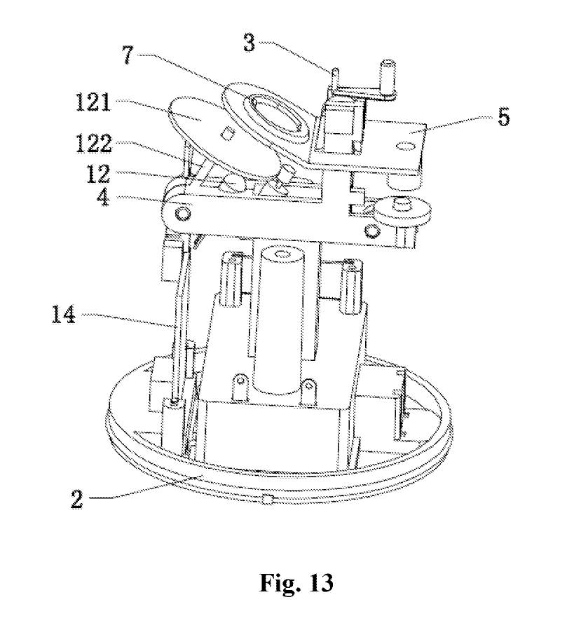

As illustrated in FIG. 13, a color plate 121 is disposed between the light-emitting element 12 and the lens 7 and mounted on the mounting bracket 4 through a support 122. In the power-on state, the light of the light-emitting element 12 runs through the color plate 121, the lens 7 and the casing through hole 101 in turn, and light emitted from the casing through hole 101 is projected onto the wall 102. More specifically, when the light-emitting element 12 is electrified, the light is emitted by the light-emitting element 12; and as color-changing lenses with different colors are disposed on the color plate 121, when the color plate 121 rotates ceaselessly, the light of the light-emitting element 12 runs through the color plate 121 to form flickering flames with different colors, and hence the objective the same with that of the embodiment 1 can be achieved.

The main technical proposal of the embodiment is basically the same with that of the embodiment 1. Unexplained characteristics in the embodiment adopt the explanation in the embodiment and will not be further described herein.

### Embodiment 6

The technical proposal of the embodiment is basically the same with that of the embodiment 1. The differences are as follows:

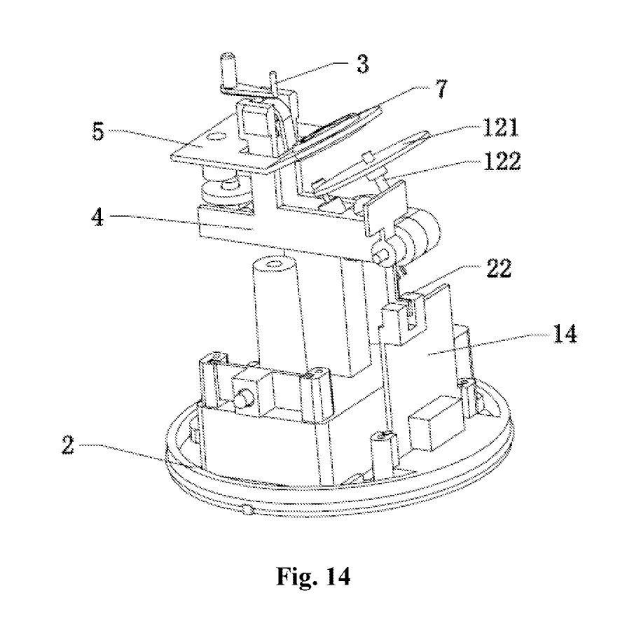

As illustrated in FIG. 14, the candlelight simulation electronic candle further comprises a photoswitch 22, wherein the photoswitch 22 is mounted on the mounting bracket 4 and connected with the light-emitting element 12. Moreover, the photoswitch 22 is connected with a time-delay device which is connected with the light-emitting element 12. More specifically, when the candlelight simulation electronic candle provided by the present invention must be extinguished, an user can blow off the flame or shake the candlelight simulation electronic candle so that the photoswitch 22 can be driven to shake and the current at both ends of the photoswitch 22 can be changed, and hence the light-emitting element 12 can be extinguished, and consequently the objective of blowing off or shaking off the flame can be achieved. Moreover, the photoswitch 22 of the candlelight simulation electronic candle is connected with the time-delay device. By the setting of the shaking duration of the photoswitch 22 in the time-delay device, the lighting or extinguishing accuracy of the light-emitting element 12 can be further guaranteed, and hence the vivid effect of the candlelight simulation electronic candle provided by the present invention can be further improved.

As the photoswitch 22 is the prior art. The detailed structure of the photoswitch 22 will not be further described herein.

The main technical proposal of the embodiment is basically the same with that of the embodiment 1. Unexplained characteristics in the embodiment adopt the explanation in the embodiment and will not be further described herein.

The above embodiments are only the preferred embodiments of the present invention and not intended to limit the scope of the present invention. All the equivalent changes or modifications made based on the structure, the characteristics and the principle within the scope of the patent application of the present invention should fall within the scope of the patent application of the present invention.

What is claimed is:

1. A candlelight simulation electronic candle, comprising a candle body shell and a candle body base, wherein the candle body shell is connected with the candle body base to form an accommodating space; a wick, a casing through hole and a wall are formed on the upper end of the candle body shell; the wick is disposed between the casing through hole and the wall; the accommodating space is provided with a mounting bracket and a lens holder is hinged to each other, and also provided with a swinging mechanism configured to drive the lens holder to swing around the mounting bracket; the mounting bracket and the lens holder are respectively provided with a light-emitting element and a lens; a gap is formed between the light-emitting element and the lens; in the power-on state, light of the light-emitting element is running through the lens and the casing through hole in turn, and light is emitted from the casing through hole projected onto the wall to form a flame; and when the swinging mechanism drives the lens to swing freely along with the lens holder, the flame which is imaged via the lens and projected onto the wall swings freely.

2. The candlelight simulation electronic candle according to claim 1, wherein a longitudinal cross-section of the wall is cambered in shape.

3. The candlelight simulation electronic candle according to claim 1, wherein a recess is formed on the upper end of the candle body shell; both the wick and the casing through hole are disposed at the bottom of the recess; and the recess and the wall are integrally formed.

4. The candlelight simulation electronic candle according to claim 3, wherein a longitudinal cross-section of the wall is cambered in shape.

5. The candlelight simulation electronic candle according to claim 3, wherein a longitudinal cross-section of the recess is cambered in shape.

6. The candlelight simulation electronic candle according to claim 5, wherein a longitudinal cross-section of the wall is cambered in shape.

7. The candlelight simulation electronic candle according to claim 1, wherein the swinging mechanism includes a control circuit mounted in the accommodating space; the lens holder and the mounting bracket are respectively provided with a magnet and a solenoid; the control circuit is electrically connected with the solenoid; and in the power-on state, the solenoid generates magnetism and the solenoid and the magnet attract or repel each other.

8. The candlelight simulation electronic candle according to claim 1, wherein the swinging mechanism includes a fan mounted in the accommodating space; the lens holder is provided with a windward baffle; and in the power-on state, the baffle is driven to swing by the wind power generated by the fan.

9. The candlelight simulation electronic candle according to claim 1, wherein the swinging mechanism includes a motor mounted in the accommodating space; the lens holder is provided with a swinging arm; a motor bushing is provided with a cam which abuts against the swinging arm; and in the power-on state, the motor drives the cam to rotate and the cam drives the swinging arm to swing.

10. The candlelight simulation electronic candle according to claim 1, wherein the mounting bracket is provided with a mounting hole capable of holding the light-emitting element, and includes a left mounting bracket and a right mounting bracket which are butted with each other; and the mounting hole is divided into two portions which are symmetrically formed on the left mounting bracket and the right mounting bracket respectively.

11. The candlelight simulation electronic candle according to claim 1, wherein the mounting bracket is provided with a swinging support; the lens holder is provided with an arch support; the swinging support runs through the inside of the arch support; and the arch support is hinged to the swinging support.

12. The candlelight simulation electronic candle according to claim 1, wherein the candle body shell is provided with a light sensor capable of sensing the illumination intensity.

13. The candlelight simulation electronic candle according to claim 1, wherein the light-emitting element is a light-emitting diode (LED) color-changing lamp.

14. The candlelight simulation electronic candle according to claim 1, wherein a color plate is disposed between the light-emitting element and the lens and rotatably mounted on the mounting bracket through a support; and in the power-on state, the light of the light-emitting element runs through the color plate, the lens and the casing through hole in turn, and the light emitted from the casing through hole is projected onto the wall.

15. The candlelight simulation electronic candle according to claim 1, wherein the candlelight simulation electronic candle further comprises a photoswitch which is mounted on the mounting bracket and connected with the light-emitting element.

16. The candlelight simulation electronic candle according to claim 1, wherein the photoswitch is connected with a time-delay device which is connected with the light-emitting element.
